(19) United States
(12) Patent Application Publication
(10) Pub. No.: US 2010/0004349 A1
(43) Pub. Date: Jan. 7, 2010

(54) METHOD FOR PRODUCTION OF THERMOPLASTIC FOAMS

(75) Inventors: Manuel Hidalgo, Brignais (FR); Jean-Marc Sage, Oullins (FR); Eric Lacroix, Amberieux D'Azergues (FR); Arnaud Radigue, Cormeilles-En-Parisis (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/302,944

(22) PCT Filed: May 9, 2007
(86) PCT No.: PCT/FR2007/051237

§ 371 Date: Apr. 28, 2009

(30) Foreign Application Priority Data
Jun. 9, 2006 (FR) 0605116

(51) Int. Cl. C08J 9/228

(52) U.S. Cl. 521/95

(57) ABSTRACT

The present invention concerns a method for production of foams of thermoplastic polymer such as polyethylene, polypropylene, polystyrene, polyvinyl chloride. More specifically its goal is a method for production of thermoplastic foams comprising a premixing step of at least a thermoplastic polymer in the form of a divided solid with at least an ester of azocarboxylic acid.

The present invention relates to a process for the manufacture of foams formed of thermoplastic polymers, such as polyethylene, polypropylene, polystyrene or polyvinyl chloride.

The use of azo compounds as blowing agents in the manufacture of polymer foams is known. Thus, azodicarbonamide is the normal blowing agent when the temperature for the manufacture of the foams is relatively high, typically greater than 150° C., and 2,2′-azobisisobutyronitrile (AZDN) is the most commonly used when the temperature for the manufacture of the foams is lower.

AZDN is a white solid which can release significant amounts of nitrogen gas in a very short time, from the moment that its processing temperature is in the region of 100° C. It is very particularly suitable for the manufacture of rigid polymer foams, for example rigid thermoplastic polymer foams.

These polymer foams, which are optionally crosslinked, have an excellent compromise between the lightness of an expanded material and the mechanical properties of a rigid material at a temperature in the vicinity of ambient temperature. They can be manufactured from different thermoplastic polymers, in particular polyethylene, polypropylene, polystyrene and polyvinyl chloride (PVC).

When AZDN, furthermore known as a polymerization initiator, is used as blowing agent in the manufacture of thermoplastic foams, the amount of product involved, with respect to the final polymer foam, can be considerable (typically several percent by weight) and greater than that employed in polymerization initiation applications (often less than 1% by weight, with respect to the final product). Thus, the incorporation of AZDN powder as a blend with at least one thermoplastic polymer in the divided solid form, such as PVC, also often used in the powder form, presents the difficulty of homogeneity of the resulting blend of the powders, which has a direct effect on the quality of the final foam, which can exhibit various types of defects, such as, for example, surface defects, or an unsuitable size or size distribution of the cells.

One of the means for solving this problem consists in using AZDN having a particularly carefully prepared particle size distribution. In point of fact, this particle size distribution is very often very difficult to obtain as it requires sieving and grading stages which are problematic from the handling and safety viewpoint due to the generation of dust.

Another disadvantage of AZDN is the formation of toxic byproducts, such as tetramethylsuccinonitrile. These products, generated during the decomposition of the AZDN, are liable to be reencountered, in not insignificant concentrations, in the final foams.

The present invention provides a process for the manufacture of thermoplastic foams which makes it possible to partially or completely overcome the above-mentioned disadvantages.

The process according to the present invention is characterized in that it comprises a stage of preblending at least one thermoplastic polymer provided in the form of a divided solid (for example, powder, granules, flakes or agglomerates), with at least one azocarboxylic acid ester of formula (I)

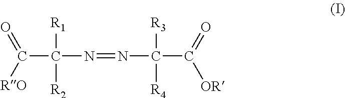

in which R₁, R₂, R₃ and R₄, which are identical or different, are independently selected from the group consisting of:
linear or branched alkyls having from 1 to 9 carbon atoms, preferably from 1 to 4 carbon atoms, optionally substituted by one or more substituents selected from hydroxyl, C₁ to C₆ alkoxy or halogen substituents;
C₃ to C₁₂ cycloalkyls, optionally substituted by one or more substituents selected from C₁ to C₆ alkyl, C₁ to C₆ alkoxy, hydroxyl and halogen groups;
aralkyls, optionally substituted by one or more C₁ to C₆ alkyl, C₁ to C₆ alkoxy, hydroxyl and halogen groups;
aryls, optionally substituted by one or more substituents selected from C₁ to C₆ alkyl, C₁ to C₆ alkoxy, hydroxyl and halogen groups;
   with at least one of the R₁-R₂ and R₃-R₄ combinations optionally being able to form an aliphatic ring; R″ and R′ are identical to or different from one another and are independently selected from the group consisting of linear or branched C₁ to C₁₀, preferably C₁ to C₄, aliphatic radicals.

In addition, these azocarboxylic acid esters have a low melting point and the stage of predissolution in a solvent before the preblending stage is not necessary. The preferred azocarboxylic acid esters are those in which R″ and R′ represent methyl or ethyl and in which R₁, R₂, R₃ and R₄ advantageously represent C₁ to C₄ alkyl groups.

The azocarboxylic acid ester which is particularly preferred is diethyl 2,2′-azobisisobutyrate, that is to say with R₁, R₂, R₃ and R₄ representing methyl and R′ and R″ representing ethyl. A mixture of diethyl 2,2′-azobisisobutyrate (DEAB) and of dimethyl 2,2′-azobisisobutyrate (DMAB) with a level of DEAB by weight preferably of greater than 50% is also preferred. Mixtures of DEAB, DMAB and methyl ethyl 2,2′-azobisisobutyrate, preferably with a molar ratio COOMe/COOEt ≦10, may be suitable.

The thermoplastic polymer is advantageously chosen from polystyrene and polyvinyl chloride, alone or as a blend with other polymers. A particularly advantageous case is that of the foams obtained from PVC also comprising polyurethane formed from diisocyanates included in the formulation to bring about expansion.

The stage of preblending the thermoplastic polymer(s) with at least one azocarboxylic acid ester of formula (I) can be carried out in the presence of other ingredients, such as plasticizers, heat stabilizers, colorants, crosslinking agents and monomers capable of polymerizing and/or crosslinking during expansion, such as di- or polyisocyanates.

The preblending stage can be carried out under controlled temperature conditions. The temperature of the preblending is preferably between 10 and 30° C.

The amount of azocarboxylic acid ester involved is preferably between 2 and 15% by weight, with respect to the polymer present in the preblending stage.

After the preblending stage, the process can comprise a stage of placing in a mold (sheets), followed by a preexpansion stage, followed in its turn by a stage of final expansion and maturing.

The azocarboxylic acid ester of formula (I) which is preferred is that which, at the temperature at which the preblend is prepared, occurs in the liquid state.

According to one embodiment of the invention, after the stage of preblending the thermoplastic polymer in the form of a divided solid (power, agglomerates, flakes, granules, and the like) with at least one azocarboxylic acid ester of formula (I) under controlled temperature conditions, the blend thus formed, to which other ingredients, such as those mentioned above, have also been able to be added, is placed in molds or containers, such as, for example, those having the shape of rectangular sheets, and it is subjected to a preexpansion stage under controlled conditions of temperature and pressure which makes possible the softening of the thermoplastic polymer and the beginning of decomposition of the azo blowing agent so as to create nuclei or seeds, from which the final expansion will subsequently develop. The preexpanded blend is subsequently cooled and reduced in pressure, which makes it possible to obtain rigid articles, for example sheets, which are subsequently subjected to the stage of final expansion and maturing by placing them under controlled conditions of temperature and humidity but at atmospheric pressure for the time necessary for the production of solid articles (sheets)of the desired shape which exhibit a multiplicity of substantially closed cells.

According to another embodiment of the invention, after the stage of preblending the thermoplastic polymer in the form of a divided solid (powder, agglomerates, flakes, granules, and the like) with at least one azocarboxylic acid ester of formula (I) under controlled temperature conditions, the blend thus formed, to which other ingredients, such as those mentioned above, have also been able to be added, is extruded through a die under pressure and temperature conditions such that, during passage through the extruder, the blend cannot completely expand and so that the bulk of the expansion takes place at the outlet of the extruder, immediately or after a given time of final expansion and of maturing of the extruded blend under controlled conditions of temperature and humidity.

The process according to the present invention makes it possible to obtain expanded foams with a homogeneous dispersion of the cells, good mechanical strength and also a good insulating performance. The foams thus manufactured are capable of being used in insulation applications, structural applications, for example windmill blades or boat hulls, or comfort applications, for example panels of train cars.

1. A process for the manufacture of thermoplastic foams, characterized in that it comprises preblending at least one thermoplastic polymer the form of a divided solid with at least one azocarboxylic acid ester of formula (I) 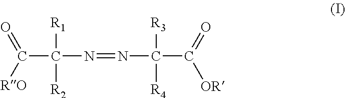
in which R₁, R₂, R₃ and R₄, are identical or different, and are independently selected from the group consisting of:
linear or branched alkyls having from 1 to 9 carbon atoms, optionally substituted by one or more substituents selected from hydroxyl, C₁ to C₆ alkoxy or halogen substituents;
C₃ to C₁₂ cycloalkyls, optionally substituted by one or more substituents selected from C₁ to C₆ alkyl, C₁ to C₆ alkoxy, hydroxyl or halogen groups;
aralkyls, optionally substituted by one or more C₁ to C₆ alkyl, C₁ to C₆ alkoxy, hydroxyl or halogen groups; and
aryls, optionally substituted by one or more substituents selected from C₁ to C₆ alkyl, C₁ to C₆ alkoxy, hydroxyl or halogen groups;
with at least one of the R₁-R₂ and R₃-R₄ combinations optionally being an aliphatic ring; R″ and R′ are identical to or different from one another and are independently selected from the group consisting of linear or branched C₁ to C₁ aliphatic radicals.

2. The process as claimed in claim 1, characterized in that R″ and R′ represent methyl or ethyl and R₁, R₂, R₃ and R₄ represent C₁ to C₄ alkyl groups.

3. The process as claimed in claim 1, characterized in that the azocarboxylic acid ester is diethyl 2,2′-azobisisobutyrate.

4. The process as claimed in claim 1, characterized in that the thermoplastic polymer is chosen from polystyrene or polyvinyl chloride.

5. The process as claimed in claim 1, characterized in that it further comprises a preexpanding step after said preblending.

6. The process as claimed in claim 5, characterized in that it further comprises an expansion step after said preexpansion step.

7. The process as claimed in claim 1 wherein said linear or branched alkyls have from 1 to 4 carbon atoms.

8. The process as claimed in claim 1 wherein said R″ and R′ are identical to or different from one another and are independently selected from the group consisting of linear or branched C₁ to C₄, aliphatic radicals.

9. The process as claimed in claim 1, characterized in that the azocarboxylic acid ester is a mixture of diethyl 2,2′-azobisisobutyrate and dimethyl 2,2′-azobisisobutyrate.
